(19) United States
(12) Patent Application Publication
(10) Pub. No.: US 2002/0095746 A1
(43) Pub. Date: Jul. 25, 2002

(54) Retractable handle device having a simplified structure

(76) Inventor: King Sheng Wang, Taichung Hsien (TW)

Correspondence Address: CHARLES E. BAXLEY, 5th Floor, 59 John Street, New York, NY, 10038, US

(21) Appl. No.: 09/765,707

(22) Filed: Jan. 22, 2001

(51) Int. Cl. E05B 7/00

(52) U.S. Cl. 16/405

(57) ABSTRACT

A retractable handle device includes one or more pairs of tubes slidably received in the conduits for forming a telescopic structure, and one or more latch devices for selectively securing the tubes to the conduits. A control device includes a handle having two ducts secured on the tubes, an actuating lever having two arms pivotally secured to the handle, and a blade disposed between the arms, and two extensions extended from the arms and coupled to the latch devices for actuating the latch devices. The actuating lever has a simplified structure.

### BACKGROUND OF THE INVENTION

1. Field of the Invention

The present invention relates to a handle device, and more particularly to a retractable handle device for a suitcase or the like and having a simplified configuration.

2. Description of the Prior Art

Typical retractable handle devices comprise two or more pairs of tubes slidably secured together for forming a retractable configuration, a handle disposed on top of the tubes, and a hand grip slidably engaged in the handle and coupled to a latch device for selectively securing the tubes together to adjust the retractable handle device to different lengths. U.S. Pat. No. 5,689,854 to Wang discloses one of the prior retractable handle devices for the suitcases. The handle and the hand grip include a complicated configuration that may not be easily manufactured and assembled.

The present invention has arisen to mitigate and/or obviate the afore-described disadvantages of the conventional retractable handle devices for suitcases.

### SUMMARY OF THE INVENTION

The primary objective of the present invention is to provide a retractable handle device for a suitcase or the like including a simplified configuration for facilitating the manufacturing and assembling of the retractable handle device.

In accordance with one aspect of the invention, there is provided a retractable handle device comprising two conduits, at least two tubes slidably received in the conduits respectively, at least one latch device for selectively securing the tubes to the conduits, and a control device including a handle having two ducts secured on top of the tubes respectively, and an actuating lever having two arms pivotally secured to the handle, and having a blade provided between the arms, and having two extensions extended from the arms and coupled to the latch device for actuating the latch device. The arms are rotated relative to the handle to force the extensions to actuate the latch device when the blade is depressed and moved relative to the handle. The actuating lever includes a simplified structure for facilitating the manufacturing and the assembling of the control device, and for reducing the manufacturing cost for the retractable handle device.

The actuating lever includes a reinforcing rib device provided between the blade and the arms for reinforcing the blade, and includes a slit formed between each of the arms and the extensions for increasing a resilience of the arms and the blade.

The arms each includes a projection extended therefrom and pivotally secured to the handle. The handle includes two cavities formed therein for rotatably receiving the projections and for pivotally securing the arms to the handle.

The control device includes two fasteners engaged through the ducts and the tubes for securing the tubes to the handle, the extensions each includes an oblong hole formed therein for slidably receiving the fasteners and for allowing the extensions to be moved relative to the fasteners and the handle.

The handle includes two fins extended therefrom and engaged into the tubes respectively, the fasteners are engaged through the fins for securing the tubes to the handle.

The handle includes two posts extended therefrom, the arms each includes an orifice formed therein for slidably receiving the posts respectively.

A hand grip is further provided and engaged with the blade for depressing the blade against the handle. The blade includes a stud extended therefrom and engaged with the hand grip.

A casing is secured to the handle and includes an opening formed therein for slidably receiving the hand grip and for allowing the hand grip to be extended outward of the casing. A limiting device is further provided for limiting the hand grip to move relative to the casing of the handle.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view of a retractable handle device in accordance with the present invention for a suitcase or the like;

FIG. 2 is a cross sectional view taken along lines 2-2 of FIG. 1;

FIG. 3 is a perspective view of the handle of the retractable handle device;

FIG. 4 is an exploded view of the handle of the retractable handle device;

FIG. 5 is a partial cross sectional view taken along lines 5-5 of FIG. 3; and

FIGS. 6 and 7 are schematic views illustrating the operation of the handle of the retractable handle device.

### DETAILED DESCRIPTION OF THE PREFERRED EMBODIMENT

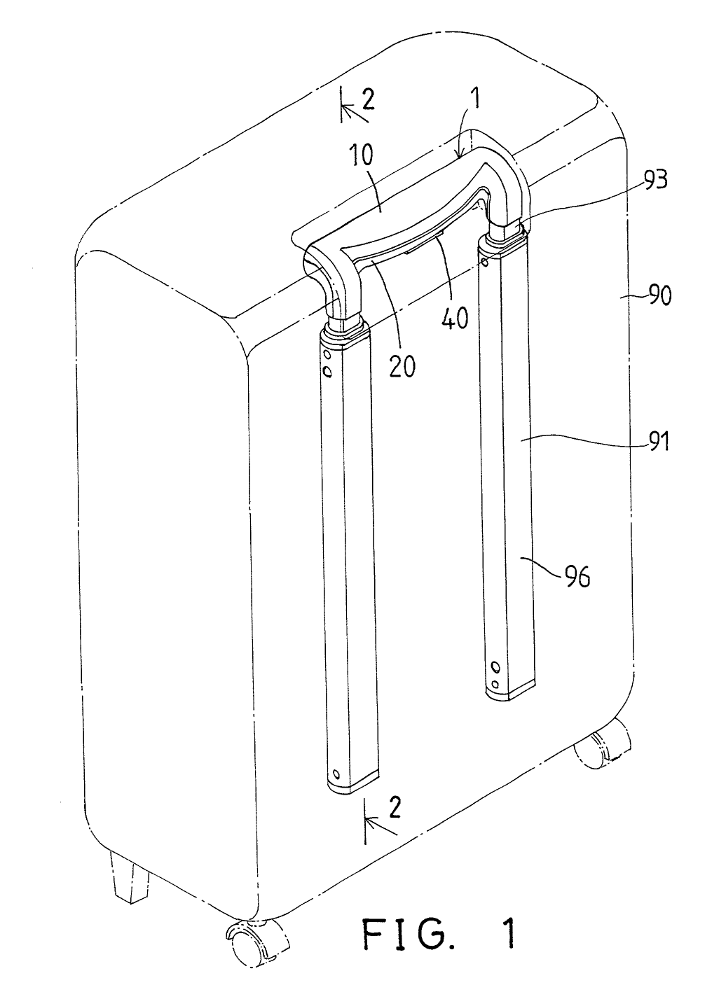

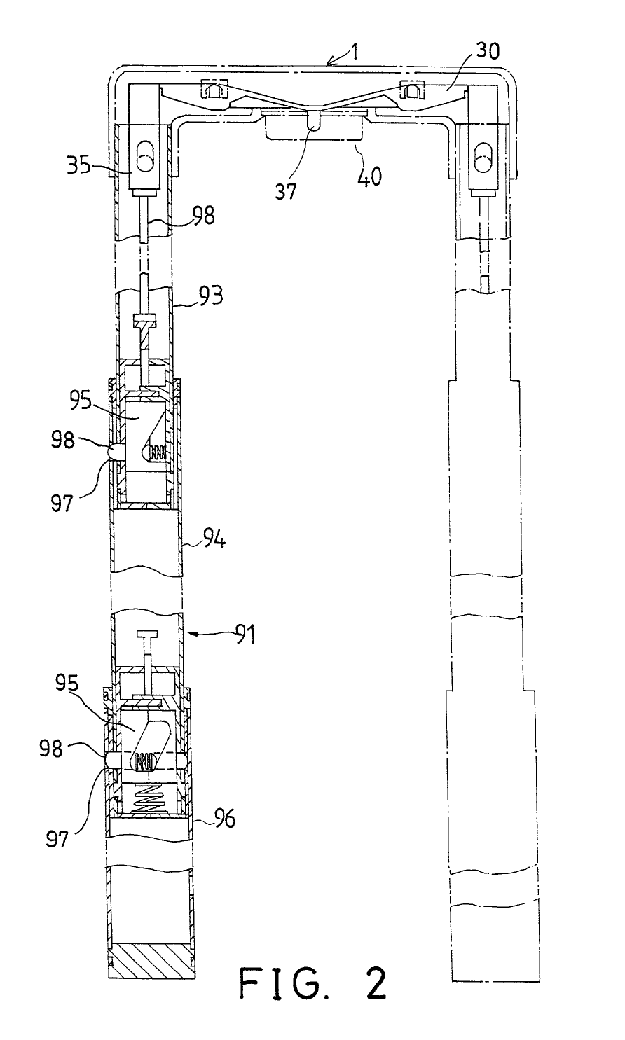

Referring to the drawings, and initially to FIGS. 1, 2, a retractable handle device in accordance with the present invention is generally designed with the reference numeral 91 and comprises a pair of conduits 96 secured to the suitcase 90 or the like, one or more tubes 93, 94 slidably received in the conduits 96 for forming the retractable or the telescopic structure, and a control device 1 disposed on top of the tubes 93, 94. One or more latches 95 are slidably received in the tubes 93, 94 and each includes a tongue 98 for engaging through the holes 97 of the tubes 93, 94 and/or of the conduits 96 for selectively securing the tubes 93, 94 and the conduits 96 together and for adjusting the retractable handle device to different lengths. The latches 95 have been widely developed and will not be described in further details hereinafter.

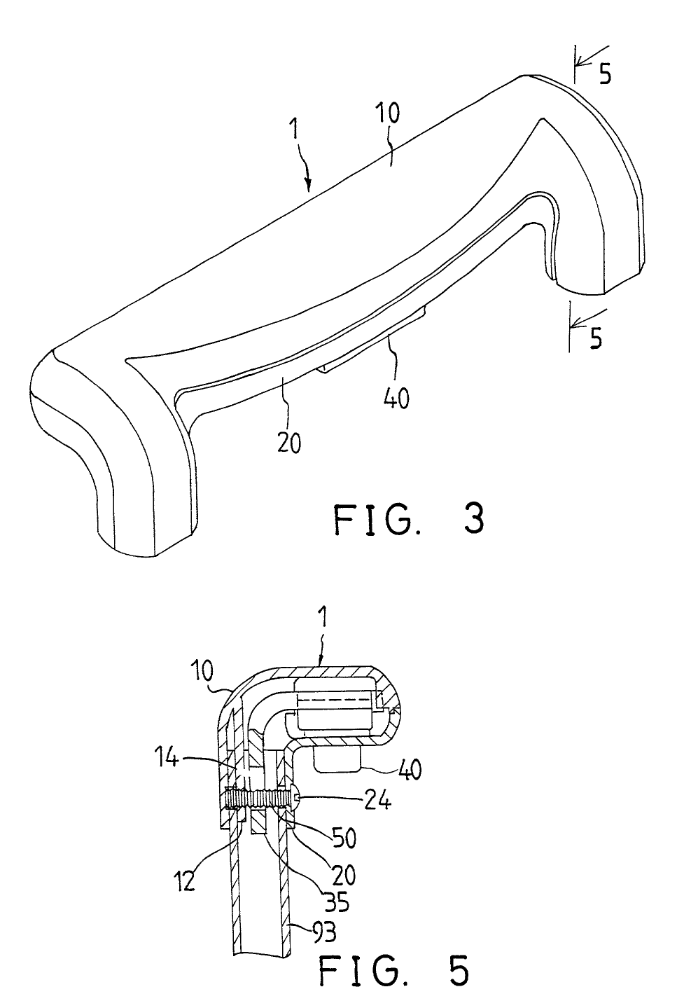

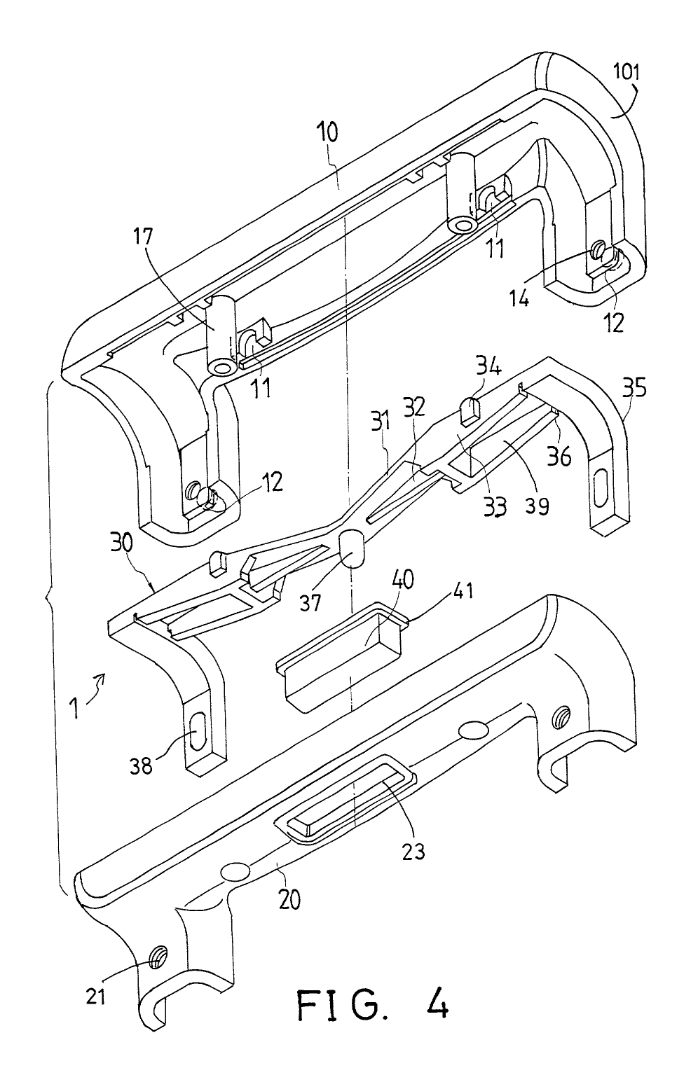

Referring next to FIGS. 3-6, the control device 1 includes a handle 10 having a casing 20 detachably secured to the bottom of the handle 10 with such as the fasteners. The handle 10 includes two spaced cavities 11 formed therein, and includes two side ducts 101 engaged onto the top ends of the tubes 93 respectively and each having a fin 12 extended therein. The fins 12 are engaged into the top ends of the tubes 93 respectively and each includes a screw hole 14 formed therein. The casing 20 includes two screw holes 21 formed therein for receiving the fasteners 24 (FIG. 5) which are threaded through the screw holes 14 of the fins 12 and are threaded or engaged through the tubes 93 for solidly securing the handle 10 on top of the tubes 93. The engagement of the fins 12 into the tubes 93 may solidly secure the handle 10 to the tubes 93 and may prevent the handle 10 from being rotating or moving relative to the tubes 93. The casing 20 includes an opening 23 formed therein for slidably receiving a hand grip 40. The hand grip 40 includes a peripheral flange 41 laterally extended outward from the upper portion thereof for engaging with the casing 20 and for limiting the sliding movement of the hand grip 40 relative to the casing 20 and for preventing the hand grip 40 from being disengaged from the casing 20.

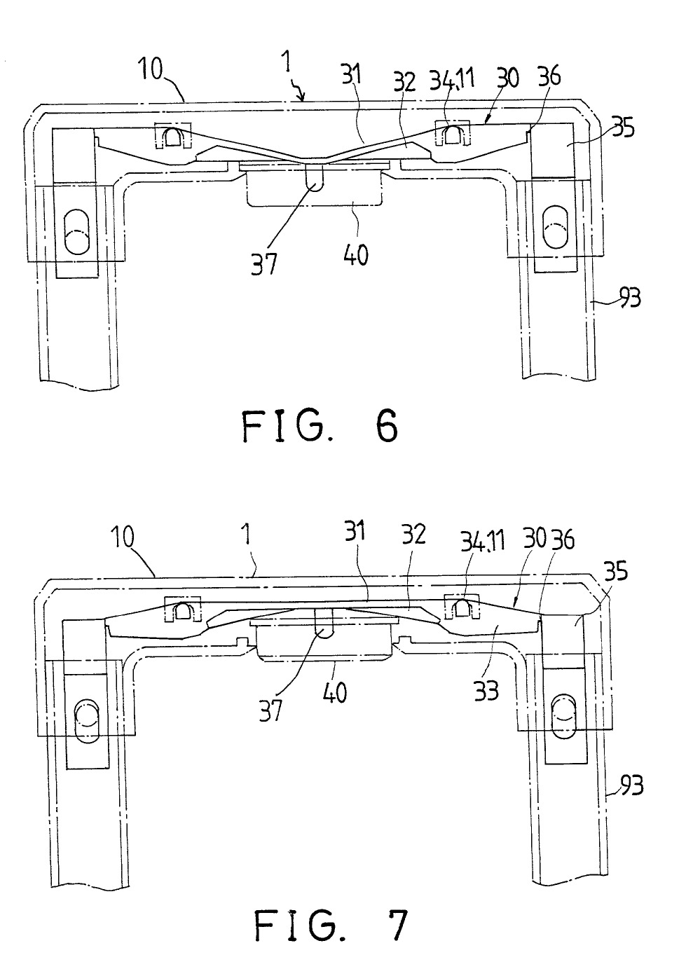

An actuating lever 30 includes two arms 33, a substantially V-shaped resilient or spring blade 31 disposed or provided between the arms 33, and two extensions 35 extended downwardly from the free ends of the arms 33 respectively. One or more slits 36 are preferably formed between the arms 33 and the extensions 35 for increasing the resilience of the blade 31 and the arms 33. One or more reinforcing ribs 32 may be provided between the blade 31 and the arms 33 for reinforcing the blade 31. The actuating lever 30 includes two spaced projections 34 extended therefrom, preferably extended from the arms 33 respectively, and rotatably received in the cavities 11 of the handle 10 for allowing the arms 33 to be rotated relative to the handle 10. The actuating lever 30 includes a stud 37 extended from the blade 31 and engaged with or secured to the hand grip 40 for allowing the blade 31 to be depressed and actuated by the hand grip 40 (FIGS. 6, 7). The extensions 35 of the actuating lever 30 each includes an oblong hole 38 formed therein for slidably receiving the fasteners 24 (FIG. 5) and for allowing the extensions 35 to be moved relative to the tubes 93. The extensions 35 are coupled to the latches 95 with links 98 or the like for actuating the latches 95 to move the tongues 98 relative to the tubes 94 or the conduits 96.

The arms 33 each preferably includes an orifice 39 formed therein. The handle 10 preferably includes two or more posts 17 extended therefrom and engaged through the orifices 39 of the arms 33 for guiding or limiting the arms 33 to move relative to the handle 10. The arms 33 and the blade 31 and the extensions 35 may be formed with such as a molding process or a mold injection process or the like, or may be formed by stamping or forging processes from a spring member.

In operation, as shown in FIG. 6, the spring blade 31 may bias the hand grip 40 downward and out of the casing 20 of the handle 10. At this moment, the extensions 35 are moved upwardly to the upper portion of the handle 10. As shown in FIG. 7, when the hand grip 40 is moved upward or inward of the handle 10 against the spring blade 31, the spring blade 31 may be straightened and may be moved upward to engage with the handle 10. The rotating engagement of the projections 34 in the cavities 11 of the handle 10 forms a pivot engagement or a pivot joint for the arms 33 and for allowing the arms 33 to be rotated relative to the handle 10, such that the extensions 35 may be moved downward and inward of the tubes 93 to actuate the latches 95. The actuating lever 30 includes a simplified configuration as compared with that of the conventional control devices for the typical retractable handle devices.

Accordingly, the retractable handle device in accordance with the present invention includes a simplified configuration for facilitating the manufacturing and assembling of the retractable handle device.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A retractable handle device comprising:
a) two conduits,
b) at least two tubes slidably received in said conduits respectively,
c) at least one latch device for selectively securing said at least two tubes to said conduits, and
d) a control device including:
i) a handle having two ducts secured on top of said at least two tubes respectively, and
ii) an actuating lever having two arms pivotally secured to said handle, and having a blade provided between said arms, and having two extensions extended from said arms and coupled to said at least one latch device for actuating said at least one latch device,
said arms being rotated relative to said handle to force said extensions to actuate said at least one latch device when said blade is depressed and moved relative to said handle.

2. The retractable handle device according to claim 1, wherein said actuating lever includes a reinforcing rib device provided between said blade and said arms for reinforcing said blade.

3. The retractable handle device according to claim 1, wherein said actuating lever includes a slit formed between each of said arms and said extensions for increasing a resilience of said arms and said blade.

4. The retractable handle device according to claim 1, wherein said arms each includes a projection extended therefrom and pivotally secured to said handle.

5. The retractable handle device according to claim 4, wherein said handle includes two cavities formed therein for rotatably receiving said projections and for pivotally securing said arms to said handle.

6. The retractable handle device according to claim 1, wherein said control device includes two fasteners engaged through said ducts and said at least two tubes for securing said at least two tubes to said handle, said extensions each includes an oblong hole formed therein for slidably receiving said fasteners and for allowing said extensions to be moved relative to said fasteners and said handle.

7. The retractable handle device according to claim 6, wherein said handle includes two fins extended therefrom and engaged into said at least two tubes respectively, said fasteners are engaged through said fins for securing said at least two tubes to said handle.

8. The retractable handle device according to claim 1, wherein said handle includes two posts extended therefrom, said arms each includes an orifice formed therein for slidably receiving said posts respectively.

9. The retractable handle device according to claim 1 further comprising a hand grip engaged with said blade for depressing said blade against said handle.

10. The retractable handle device according to claim 9, wherein said blade includes a stud extended therefrom and engaged with said hand grip.

11. The retractable handle device according to claim 9 further comprising a casing secured to said handle, said casing including an opening formed therein for slidably receiving said hand grip and for allowing said hand grip to be extended outward of said casing.

12. The retractable handle device according to claim 11 further comprising means for limiting said hand grip to move relative to said casing of said handle.
